(19) United States
(12) Patent Application Publication
(10) Pub. No.: US 2002/0071540 A1
(43) Pub. Date: Jun. 13, 2002

(54) Application service provider configuration and method for a conferencing environment

(75) Inventor: David S. Dworkin, Amherst, NH (US)

Correspondence Address: Anthony P. Onello, Jr. Esq., MILLS & ONELLO, ELEVEN BEACON STREET, SUITE 605, Boston, MA, 02108, US

(73) Assignee: CuseeMe Networks, Inc.

(21) Appl. No.: 09/735,828

(22) Filed: Dec. 13, 2000

(51) Int. Cl. H04M 3/42

(52) U.S. Cl. 379/202.01

(57) ABSTRACT

An application service provider (ASP) environment for conferencing makes conference hosting capability available to a wider user audience, at a cost that is economical for less-frequent users. In the ASP environment, users in the form of individuals and/or group customers lease conferencing capability from a host. The host ASP provides the conferencing hardware and software at a remote host site, and provides an interface in the form of standalone software installed on the user computer, or in the form of a web-based environment. Users access the host ASP electronically via dial-in or web-based interface and following an initial registration procedure, can schedule and administer conferences remotely, according to individual needs. Provisions are made for popular instant messenger applications, wherein a user can immediately invite another registered user to participate in a conference. Further optional features include user email, video mail, voice mail and calendar features, as well as wireless capability, including voice participation in a conference via wireless telephone.

### BACKGROUND OF THE INVENTION

As Internet-based telephony and conferencing applications continue to gain in popularity, there is an ever-increasing demand for affordable conferencing solutions. Currently, hosting a conference involves a large amount of overhead in terms of hardware, software, and support personnel. A powerful server is required, for example one which is capable of handling the extremely high-bandwidth distribution of video and audio data between conference participants. Additionally, sophisticated conferencing software is required at the server for enabling and managing the conference. Further, support personnel are necessary for administering the conference and maintaining the server, with periodic software upgrades as necessary. For these, and other, reasons, the hosting of video conferences has traditionally involved a high financial cost.

### SUMMARY OF THE INVENTION

The present invention is directed to a method and apparatus for hosting conferences that overcomes the limitations of conventional configurations. In particular, the present invention provides an application service provider (ASP) environment for hosting conferences. In this manner, conferencing is made available to a wider user audience, at a cost that is economical for less-frequent users.

In the application service provider environment of the present invention, users in the form of individuals and/or group customers lease conferencing capability from a host. The host ASP provides the conferencing hardware and software at a remote host site, and provides an interface in the form of standalone software installed on the user computer, or in the form of a web-based environment. Users access the host ASP electronically via dial-in or web-based interface and following an initial registration procedure, can schedule and administer conferences remotely, according to individual needs. Provisions are made for popular instant messenger applications, wherein a user can immediately invite another registered user to participate in a conference. Additional optional features include user email, voice mail and calendar features, client billing and tracking, as well as wireless capability, including voice participation in a conference via wireless telephone.

In a first embodiment, the present invention is directed to a system for remote conferencing. The system includes a user interface for transmitting and receiving conferencing data. The conferencing data includes a request for conferencing services. A host in remote communication with the user interface provides for conferencing services. The host includes a bank of conferencing services, and allocates the conferencing services to the user interface in A response to the user request. The host provides the allocated conferencing services to the user interface to enable transmission and reception of the conferencing data.

In a preferred embodiment, the conferencing data comprises command data and audio/video conferencing data. A first application programmatic interface may be provided at the user interface for generating the command data and a second application programmatic interface may be provided at the host, the first and second application programmatic interfaces being adapted for sending and receiving the command data.

The user interface may further comprise an instant messenger function for inviting secondary users to participate in a conference, and for receiving invitations from secondary users to participate in a conference. The host may further include an instant messenger function for initiating and managing instant messenger activity between user interfaces registered for such activity.

The user interface and the host are preferably coupled to, and exchange the conferencing data over, a data transmission medium, for example the Internet. The user interface may comprise a web-based interface including a web page environment generated by the host and provided to the user interface, or, optionally, may comprise a web-based interface including a web page environment generated by a third party and provided to the user interface.

The host preferably includes a conference service allocator for allocating the conferencing services according to resource demands required for a conference. The host may further include an instant messenger function for managing instant messenger activity between user interfaces registered for such activity. The host may further include a user directory for cataloging registered user interfaces for instant messenger activity. The host may further include service functions selected from the group of service functions consisting of: user calendar; user email; conference service news; and wireless links.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a conferencing architecture and method in accordance with the present invention, illustrating the use of a remote application service provider for hosting a conference.

FIG. 2 is a block diagram of an embodiment of an application service provider for the configuration of FIG. 1, in accordance with the present invention.

FIG. 3 is an example web-based user interface, in accordance with the present invention.

### DETAILED DESCRIPTION OF PREFERRED EMBODIMENTS

Sophisticated hardware and software currently exists for providing voice and video communications, conferencing, and infrastructure based on these technologies, to individuals, companies, and service providers. The present invention enables such users to benefit from enhanced communications without incurring the costs associated with the design, infrastructure, and administration of these services. By leveraging the services and infrastructure of a mature conferencing provider, users are able to focus on their core competencies while benefitting from enhanced, integrated communications services.

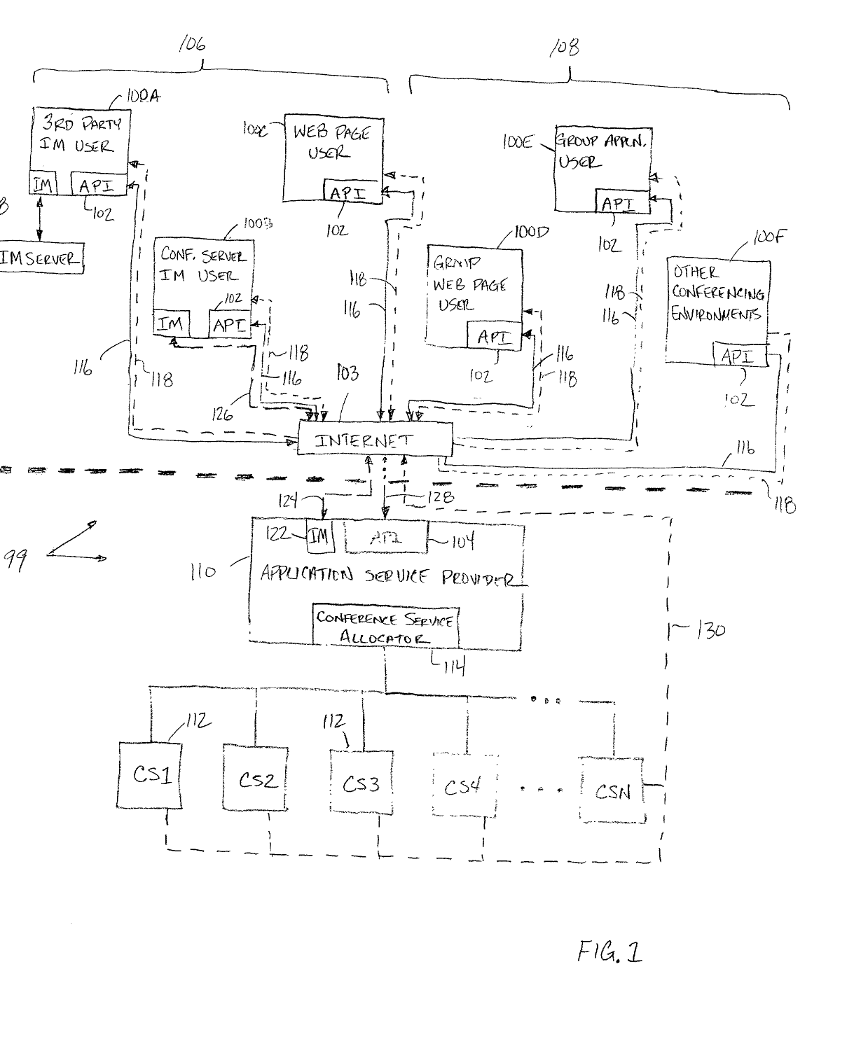

With reference to FIG. 1, a distributed conferencing configuration 99 includes a variety of users 100A-100F, including both individual, or personal, users 106, and group users 108. The users 100 are preferably interfaced with the Internet 104 for bidirectional communication of conferencing control data (indicated by solid lines 116) and audio/video conferencing data (indicated by dashed lines 118). Conference hosting hardware and software, referred to herein as conferencing resources 112, are hosted at, and managed by, a conferencing application service provider 110, remote to the users 100, and likewise coupled to the Internet 104 for bidirectional communication of control data 128 and conferencing data 130.

The users 100 are of various types and may utilize any of a number of interfaces. Personal users 106 may comprise individuals with a desire to create private group audio, data and video conferences, without the expense and overhead of owning and maintaining their own conference resources. The group users 108 may comprise customers such as portal sites or community sites that purchase conference resource availability in bulk and maintain responsibility for providing the conferencing interface to, and handling registration and billing of, their own customers. Alternatively, a group user 108 may comprise a corporation or group that rents or leases conference resources from the host in bulk, and make the resources available to employees, either via a corporate-specific interface that keeps track of internal allocation of resources, conference scheduling and billings, or through a web interface provided by the host ASP 110.

In a first example, the user may comprise an individual user 100A using a private, third-party instant messaging server 98. In this instance, the user 100A would first register with the host ASP, for example providing contact name and billing information. A particular service is requested, for example a pay-as-you-go or subscriber model service. once registered, the user 100A is provided a conferencing “add-on” from the host ASP, which provides the user with an application programmatic interface (API) 102 which includes a library of commands necessary for scheduling, initiating, and modifying conferences. The user API 102 provides command data 116 to a similar host API 104 via the Internet 103. The host ASP 110, in turn validates the user information, schedules and/or allocates the conferencing resources 112 for the user at the host conference service allocator 114, and establishes a conferencing data link 130, 118 between the conferencing resources 112, the user 100A and any invited guests. In the case of the individual user 100A example using a third party instant messaging server 98, the invitees may comprise other users of that same third party service.

In another example, the individual user 100B may comprise an instant messaging user utilizing instant messaging resources available from the ASP 110 instant messaging utility 122. In this case, the user 100B registers for conferencing service, as above, but additionally registers for instant messaging capability with the host ASP 110. Upon registration, the ASP 110 instant messaging utility 122 provides the host API 102 information and instant messaging plug-ins to the user interface 100B, in order to make the user's interface compatible with the ASP 110. The user 100B initiates a conference by inviting other instant messaging participants registered with the ASP 110, and in response, the ASP 110 allocates conferencing resources 112 in accordance with the instant messaging request. In this case, the instant messaging server 122 is located at the ASP, and an instant messaging data link 124, 126 is created through the Internet interface 103.

In a third example, the individual user 100C may comprise a user gaining access to the ASP through a web site provided by the host ASP 110. The web site may prompt a new user 100C for registration and billing information, and provides login access for registered users. Once registered, a user is provided with an add-on, including an API command interface 102, as described above. The user 100C may be provided with a fully supported web page, including conferencing capability built into the page, as shown and described below with reference to FIG. 3, or, at the user's option, only conferencing information is returned to the user, through the user API 102, and the conferencing environment type is chosen by the user 100C.

FIG. 3 is an example web-based user interface 146, illustrating the types of services that may be provided by the host ASP 110 to individual and group users 106, 108, in accordance with the present invention. The web interface 146 includes a user calendar, for example maintained and updated at the ASP 110, for providing a user with a schedule of upcoming conferences and other user-defined scheduling information. An e-mail 150 and news 152 service may also be provided. A conference window 156 includes video images 158 of conference participants, along with active textual chat 160 and audio data streams transmitted over the computer speakers. Returning to FIG. 1, examples of group users 108 include a web-page-based group user 100D, 100E wherein a group customer, such as a portal or corporation, provides access to group members via a web-based interface, in a manner similar to the individual user web interface 100C described above. In the group-user case, however, depending on the type of service purchased, the group customer, for example user 100E, may be responsible for creating and maintaining its own web pages. In this case, the group customer 100E is provided with the API 102 information required for interfacing with the host API 104. Alternatively, the host ASP 110 may provide the interface for the group 100D, which may be customized by the group customer to provide the particular group “look and feel” to the group user.

In another group user example, a group may choose to operate under a third-party conferencing environment 100F, in which case, the group interfaces with the host ASP through API interfaces 102, 104. The group is responsible for operating and maintaining its own conferencing environment, and the host provides the API interface 102 and allocates conference resources according to the group resource subscription. Alternatively, group users may take the form of ASP-hosted instant messaging applications or third-party instant messaging applications, as described above in the context of individual users.

The application service provider 110 includes resources related to personal and group communications services, including conference rooms, user tracking services, instant messaging services, optional instant messaging user directory, and a conference service allocator.

The building blocks of the present ASP configuration, upon which all services are built, are the conference room and the personal and group communications services. A conference room may be public or private, a basic or premium level, “buddy-chat” or “group chat”, for example. The ASP configuration offers these variation in bulk quantities for the end users, which, as described above may include Internet service providers, portals, and corporations.

The ASP structure of the present invention serves to map high-level services onto low-level technology resources, for example a permanent public video chat room may be mapped onto a configured conference, or a permanent personal conference identification may be mapped onto a dynamic conference or a messaging service. It is this infrastructure that manages allocation and configuration of resources such as conference servers and ports, messaging services, streaming services, gateways, and the like, for example by conference service allocator 114. Such management may be static, allocating permanent resources, or alternatively dynamic, allocating resources for a designated time period. Resource allocation methods may operate with singular services, or bulk services.

Initially, a user may register for service, for example using customer administration tools loaded on a stand-alone computer, or a web-based system, as described above. Registration information may include the following: company name and address, contact information, billing information, authorized monthly charge limit, and an administrative password. Purchasing may be accomplished via a generic web page that requests the customer account number and password and displays available services and purchase-time options. Notification of purchase services may be sent via email.

Conference rooms may be rented on a long term basis, for example monthly, on-demand as needed, or by schedule, for example at a specified time, date, and duration. Conference rooms may be published or unpublished, and may be designated “open”, where any registered user may join in the conference, or “protected”, where only certain invited users may participate. A conference room publishing service may provide a sign up sheet for scheduling and publishing of available conferences. The conference room service is capable of supporting layered ASP services, for example instant messaging, as described above, and further supports personal communications that extend the conferencing environment to include traditional telephony capabilities. For example, incoming conference calls can be dynamically routed to a user's personal computer, telephone, or wireless device via gatekeepers, gateways, IP/PBXs, and directory services. Enhanced features such as call forwarding, caller ID and filtering, and call merging may be further provided.

In a preferred embodiment, the ASP offers many or all of these pre-configured high-level services for the conferencing environment. Most options are selected at the time of purchase of the service, therefore dynamic configuration is minimal. Purchase-time options may include the video chat room name and size, the video chat room password for access to the chat rooms' schedule and reservations, the chat room bandwidth, environment, and video and sound quality of the conference.

Conference room services may permit users to establish small group conferences and collaborative conferences on-demand. Designated conference participants are notified by the ASP, and connected to scheduled conferences at start time. Streaming services are preferably available for conference recording and playback, and for live broadcast of conferences. Services include, for example, whiteboarding (simultaneous modification of a graphic or textual presentation), application sharing (simultaneous operation of a shared singe instance of an application), web touring (concurrent navigation of web pages), moderation (moderator determines when and how participants interact with the conference), and group polling (real-time question and answer sessions).

A publishing service is preferably provided to the ASP customer including a mechanism for reserving and viewing reservations of a conference room rented by the customer. The service is preferably provided via a password-protected URL specific to the customer in the conference room. First and second tiers of authentication protect first, access to the conference room from access by other ASP customers, and second, ensures that only authorized end-users enter a reserved conference.

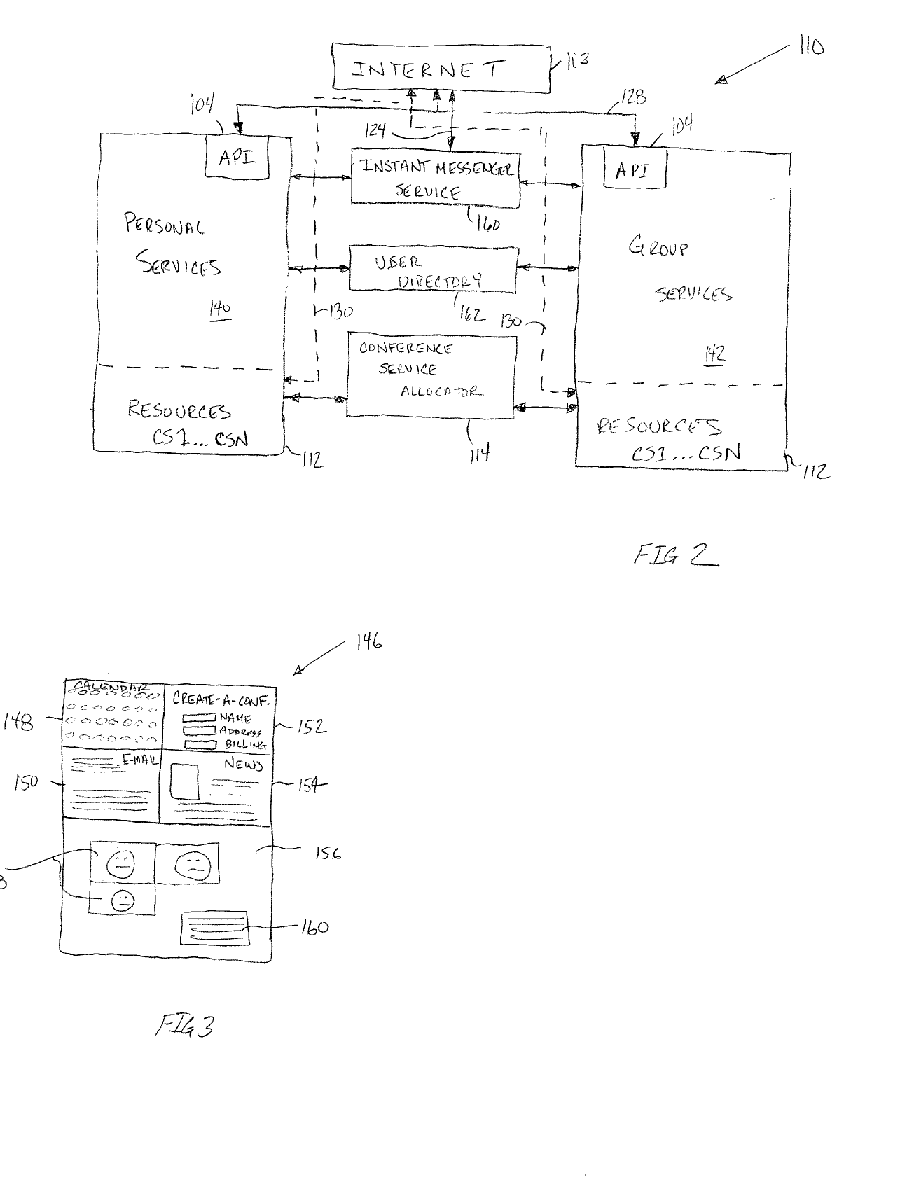

FIG. 2 is a block diagram of a preferred embodiment of a host ASP 110. The ASP 110 preferably provides for personal services 140 and group services 142 for the benefit of individual and group users, as described above. Conferencing commands are received at an API interface 120 via command lines 128, coupled to the Internet 103. The personal and group services 140, 142 include associated conferencing resources 112, which are allocated by a conference service allocator 114, based on the command data. Once established, a conference utilizing the conferencing resources communicates conference data to participants over the Internet 103, via a conference data link 130.

The host ASP 110 further includes an instant messaging service 160 for providing audio, video, and textual instant messaging capabilities, as described above. An instant messaging data link 124 communicates instant messaging command data to and from users via the Internet 103. The instant messaging service 160 further communicates with the personal and group services 140, 142 and resources 112, to ensure instant messaging support by the host resources 112.

A user directory 162 is provided to assist users in locating other users, events and conferences, and to manage calls and events. User registration information is maintained and updated, user profile information is maintained, and presence information related to whether a given user is online or offline is stored. Further capabilities for user-specified buddy lists, search capabilities involving conferences, and search capabilities to locate users and events are also made available to users. Personal services such as user-defined automated calling and scheduling, for example using personal information managers and online calendar services enhance the user experience. Further services, such as authentication of users, usage tracking and billing, and conference schedule publishing ensure system security and profitability.

By distributing the conferencing architecture to remove the expense and overhead involved in operating and maintaining the conferencing server software and hardware, a novel conferencing configuration is achieved, in a manner that makes audio, video, and textual conferencing, as well as other communication tools, such as voice mail, video mail, email, etc., available to a wider audience of users. The conferencing system and method of the present invention are flexible according to user needs, as they allow individual users to have access to conferencing capability on an as-needed basis, and allows group users to lease conferencing resources on a bulk basis, according to each customer's needs. Full-service conferencing capabilities are thus achieved in a manner that is economical for both user and host ASP.

While this invention has been particularly shown and described with references to preferred embodiments thereof, it will be understood by those skilled in the art that various changes in form and details may be made herein without departing from the spirit and scope of the invention as defined by the appended claims.

We claim:

1 A system for remote hosting of a conference comprising:
a user interface to for transmitting and receiving conferencing data, said conferencing data including a request for conferencing services; and
a host in remote communication with the user interface for providing conferencing services, said host including a bank of conferencing services, said host allocating said conferencing services to said user interface in response to said request received from said user interface, said host providing said allocated conferencing services to said user interface to enable transmission and reception of said conferencing data.

2 The system of claim 1 wherein the conferencing data comprises command data and audio/video conferencing data.

3 The system of claim 2 further comprising a first application programmatic interface at the user interface for generating said command data and a second programmatic interface at the host, said first and second application programmatic interfaces for sending and receiving said command data.

4 The system of claim 1 wherein the user interface further comprises an instant messenger function for inviting secondary users to participate in a conference, and for receiving invitations from secondary users to participate in a conference.

5 The system of claim 4 wherein the host further includes an instant messenger function for initiating and managing instant messenger activity between user interfaces registered for such activity.

6 The system of claim 1 wherein the user interface and the host are coupled to, and exchange said conferencing data over, a data transmission medium.

7 The system of claim 6 wherein the data transmission medium comprises an Internet medium.

8 The system of claim 1 wherein the user interface is a web-based interface including a web page environment generated by the host and provided to the user interface.

9 The system of claim 1 wherein the user interface is a web-based interface including a web page environment generated by a third party and provided to the user interface.

10 The system of claim 1 wherein the host comprises a conference service allocator for allocating the conferencing services according to resource demands required for a conference.

11 The system of claim 1 wherein the host further includes an instant messenger function for initiating and managing instant messenger activity between user interfaces registered for such activity.

12 The system of claim 11 wherein the host further includes a user directory for cataloging registered user interfaces for instant messenger activity.

13 The system of claim 1 wherein the host further includes service functions selected from the group of service functions consisting of: user calendar; user email; conference service news; and wireless links.

14 A method for remote hosting of a conference comprising:
operating a user interface for transmitting and receiving conferencing data, said conferencing data including a request for conferencing services; and
providing a host in remote communication with the user interface for providing conferencing services, said host including a bank of conferencing services, said host allocating said conferencing services to said user interface in response to said request received from said user interface, said host providing said allocated conferencing services to said user interface to enable transmission and reception of said conferencing data

15 The method of claim 14 further comprising registering, at the user interface, as a conference participant.

16 The method of claim 14 further comprising leasing an allocation of conferencing services for a predefined group of users.

17 The method of claim 14 wherein the conferencing data comprises command data and audio/video conferencing data.

18 The method of claim 17 further comprising a providing a first application programmatic interface at the user interface for generating said command data, and providing a second programmatic interface at the host, said first and second application programmatic interfaces for sending and receiving said command data.

19 The method of claim 14 further comprising providing an instant messenger function at the user interface for inviting secondary users to participate in a conference, and for receiving invitations from secondary users to participate in a conference.

20 The method of claim 19 further comprising providing an instant messenger function at the host for initiating and managing instant messenger activity between user interfaces registered for such activity.

21 The method of claim 14 further comprising coupling the user interface and the host to a data transmission medium for the exchange of said conferencing data.

22 The method of claim 21 wherein the data transmission medium comprises an Internet medium.

23 The method of claim 14 further comprising providing the user interface as a web-based interface including a web page environment generated by the host and provided to the user interface.

24 The method of claim 14 further comprising providing the user interface as a web-based interface including a web page environment generated by a third party and provided to the user interface.

25 The method of claim 14 further comprising providing the host with a conference service allocator for allocating the conferencing services according to resource demands required for a conference.

26 The method of claim 14 further comprising providing the host with an instant messenger function for initiating and managing instant messenger activity between user interfaces registered for such activity.

27 The method of claim 26 further comprising providing the host with a user directory for cataloging registered user interfaces for instant messenger activity.

28 The method of claim 14 further comprising providing the host with service functions selected from the group of service functions consisting of: user calendar; user email; conference service news; and wireless links.
